(19) United States
(12) Patent Application Publication
(10) Pub. No.: US 2004/0156714 A1
(43) Pub. Date: Aug. 12, 2004

(54) Recirculation structure for turbo chargers

(76) Inventor: Peter Seitz, Bergkirchen/Guending (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/473,152

(22) PCT Filed: Feb. 26, 2003
(86) PCT No.: PCT/DE03/00623

(30) Foreign Application Priority Data
Feb. 28, 2002 (ZA) 02/1688
Aug. 23, 2002 (DE) 102 38 837.7

(51) Int. Cl. F03B 1/00

(52) U.S. Cl. 415/182.1

(57) ABSTRACT

Recirculation structure for turbocompressors, having a ring chamber which is arranged in the area of the free blade ends of a blade ring largely upstream of the latter, adjoins the main flow duct, and having a plurality of guiding elements which are arranged in the ring chamber, are distributed over its circumference and are arranged and shaped in a fluidically advantageous manner with respect to the recirculation flow, the guiding elements having recesses in the leading and/or trailing area of the ring chamber.

The side of the ring chamber which adjoins the contour of the main flow duct is open along its axial length as well as along its entire circumference, the free edges of the guiding elements being situated on the or close to the contour of the main flow duct.

The invention relates to a recirculation structure for turbocompressors, according to the preamble of claim 1, as well as to an aircraft engine and an industrial gas turbine.

Recirculation structures for turbocompressors have been known for some time and, as a rule, are called “casing treatments” in the art. These primarily have the task of increasing the aerodynamically stable operating range of the compressor, in which case the so-called surging limit is displaced toward higher compressor pressures, that is, toward a higher compressor stress. The disturbances responsible for a local stall and, in the end, for the surging of the compressor, on the casing side, occur at the moving blade ends of one or more compressor stages and, on the hub side, at the radially interior guide blade ends because, in these areas, the aerodynamic stress is the highest. As the result of the recirculation of the “air particles” circulating between the blade tips at the rotational blade speed and having reduced energy into the main stream while the energy is increased, the flow in the area of blade ends is stabilized again. Since, as a rule, flow disturbances do not occur uniformly over the stage range, it should be possible to fluidically, achieve a compensation in the circumferential direction in addition to the essentially axial recirculation. The main disadvantage of the known “casing treatments” is the fact that, although they increase the surging limit, they equilaterally reduce the pressure coefficient.

German Patent Document DE 33 22 295 C3 protects an axial fan having a “casing treatment” of the above-mentioned type. A ring chamber (8) is illustrated there in which guiding elements (9) are fixedly arranged. In the downstream area over the running blade ends, an area is situated which is open in the circumferential direction and into which the guiding elements do not extend. A closed ring (7), which is aligned approximately with the contour of the main flow duct, is characteristic of this type of “casing treatment”, which ring (7) separates the trailing entry area from the leading outlet area of the recirculation structure and forms a smooth closed surface area.

A very similar “casing treatment” is known from German Patent Document DE 35 39 604 C1, in which case, an area exists in the leading and trailing area of the ring chamber (7) which is open in the circumferential direction. The radially interior ring 6 should also be observed here.

A more novel “casing treatment” is known from U.S. patent Document U.S. Pat. No. 5,282,718 A. Here, the ring chamber (18, 28) and the guiding elements (24) are fluidically refined. Here also, the inlet and the outlet of the recirculation flow are separated by a solid ring which is smooth and closed toward the blades. Such rings in the blade area, as a rule, have to be equipped with a grazing or abradable coating in the event of a contact with the blade tips.

Additional “casing treatments” with axial or axially diagonal grooves, are disclosed, for example, in U.S. patent Document U.S. Pat. No. 5,137,419 A. These are not considered here because, in the absence of a mutual connection of the grooves, no flow compensation can take place in the circumferential direction in these versions.

In view of the disadvantages of the solutions according to the prior art, it is an object of the invention to provide a recirculation structure for turbocompressors, which permits clear increase of the surging limit and thus a clear enlargement of the stable operating range without any relevant impairment of the pressure coefficient.

This object is achieved by means of the features characterized in claim 1 in conjunction with the type-forming features in its preamble.

The essence of the invention is the fact that the ring chamber with the guiding elements is completely open toward the main flow duct along its axial length and its circumference. Ring-type elements with grazing coatings, etc. are eliminated. The above-mentioned patent documents demonstrate that, up to now, the technical world had attempted to construct recirculation structures toward the main flow duct, that is, toward the so-called annulus, to be smooth, without gaps and closed along an axial area which is as large as possible in order to cause a lengthening of the contour of the main flow duct which is as favorable to the flow as possible and has low losses. In contrast, the invention results in gaps, fissured surfaces, etc. and therefore appears to be disadvantageous and in expedient. However, tests have shown that the recirculation structure according to the invention is superior to known solutions with respect to the rise of the surging limit as well as with respect to the efficiency. Aerodynamically, this can be explained in that the free and unforced forming of the recirculation flow in the open ring chamber with free standing guiding elements and flow connections in the circumferential direction is more important than a lengthening of the contour of the main flow duct which is as gap-free as possible. The absence of a closed ring has the additional advantages that no grazing or abradable (inlet) coating is required for the guiding elements, and radial space as well as weight are saved which results in structure-mechanical advantages.

Preferred embodiments of the recirculation structure according to the main claim are characterized in the subclaims.

The invention will be explained in detail in the following by means of the drawing.

FIG. 1 is a partial longitudinal sectional view of a compressor in the axial construction in the area of a casing-side recirculation structure;

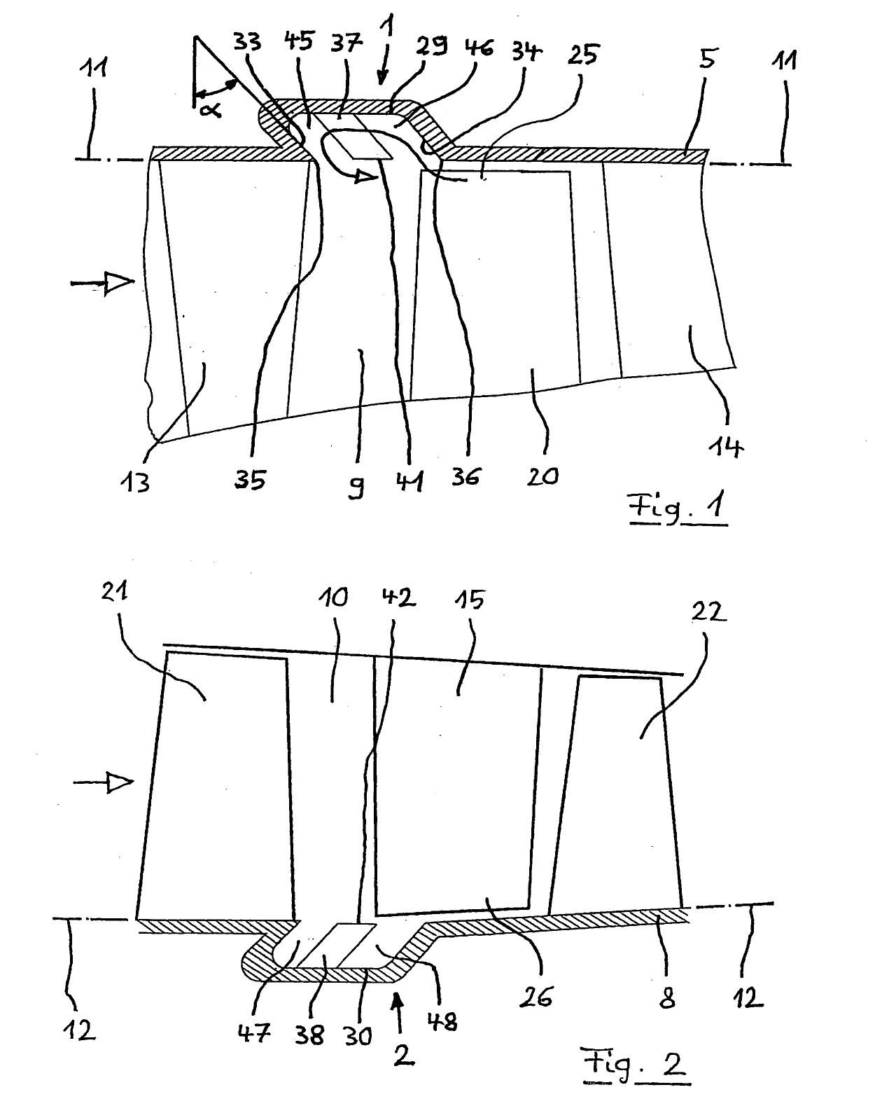

FIG. 2 is a comparable partial longitudinal sectional view in the area of a hub-side recirculation structure;

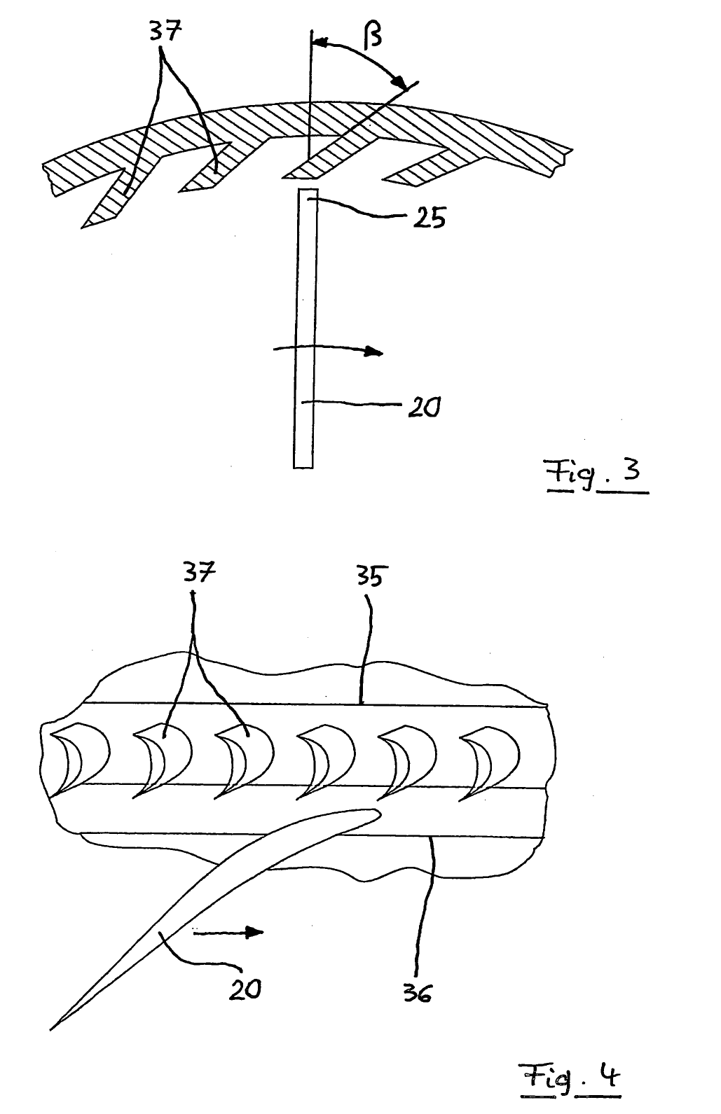

FIG. 3 is a partial cross-sectional view of the recirculation structure according to FIG. 1;

FIG. 4 is a partial view, radially from the interior, of the recirculation structure according to FIGS. 1 and 3;

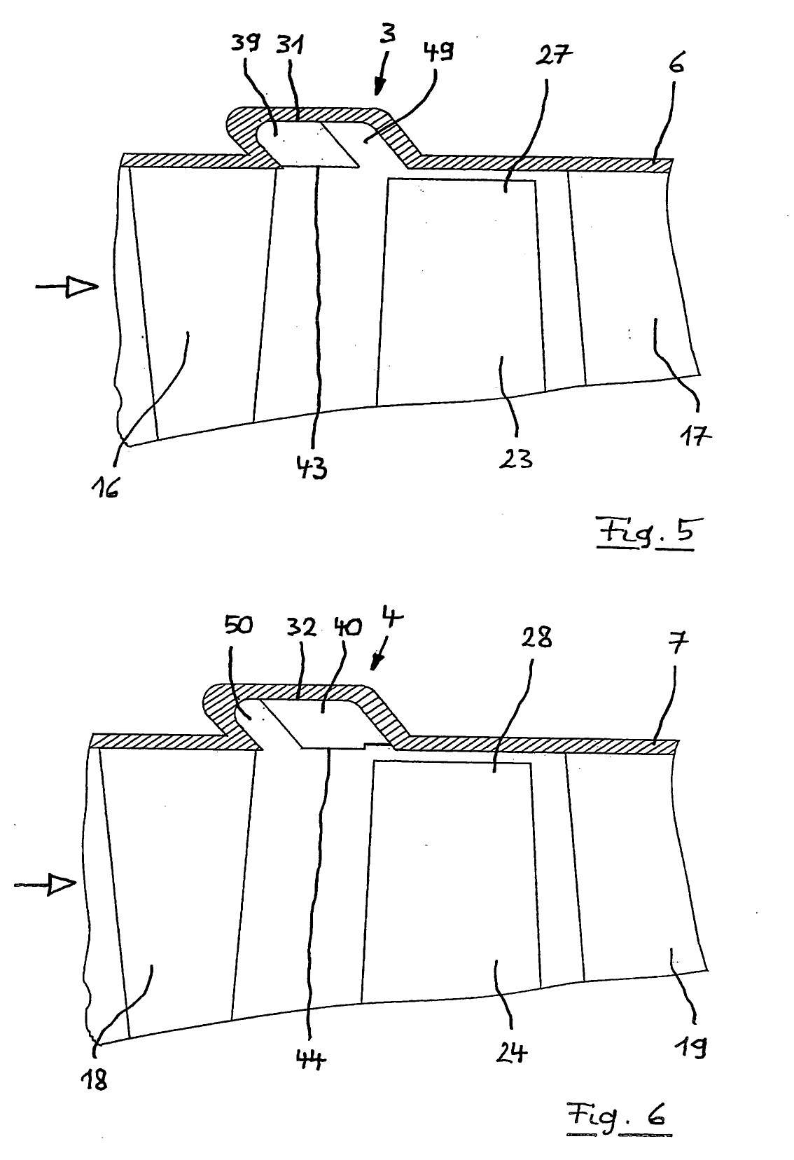

FIG. 5 is a partial longitudinal sectional view in the area of a casing-side recirculation structure modified in comparison to FIG. 1;

FIG. 6 is a partial longitudinal sectional view in the area of a casing-side recirculation structure modified in comparison to FIGS. 1 and 5.

The recirculation structure 1 according to FIG. 1 is integrated in the casing 5 of a turbocompressor and is therefore called a “casing treatment”. The flow direction in the bladed main flow duct 9 is indicated on the left by means of an arrow and therefore extends from the left to the right. In the illustrated area, the flow first encounters a guide blade ring 13, then a moving blade ring 20 and finally again a guide blade ring 14. The radially outer contour 11 of the main flow duct 9 corresponds to the inner contour of the casing 5 and, for a clear illustration, is continued in a dash-dotted manner on the left and right of the actual representation. The static recirculation structure 1 interacts with the running blade ring 20 and is situated largely axially in front of the latter, that is, upstream. The ring chamber 29 which, together with the guiding elements 37, forms the recirculation structure 1, adjoins the main flow duct 9 radially from the outside and is open in its direction. The free edges 41 of the guiding elements 37 are situated on or close to the contour 11 of the main flow duct 9; that is, they are at least approximately aligned with the inner contour of the casing. The guiding elements 37 may consist of a metal, such as an Ni base alloy, or of a light metal, such as Al, or of a plastic material, such as thermoplastics, duroplastics or elastomers. Starting from their radially interior edges 3, 36, the leading wall 33 and the trailing wall 34 of the ring chamber 29 are sloped forward in order to be fluidically advantageous for the recirculation indicated by a small arrow.

The angle of slope of the leading wall is marked by the letter α; it may be identical or different in relation to the angle of the trailing wall 34. Recesses 45, 46 exist between the leading wall 33, the guiding elements 37 and the trailing wall 34, which recesses 45, 46 permit flow events within the ring chamber in the circumferential direction, in addition to the predominantly axially occurring recirculation. Reference number 25 indicates the free blade ends of the running blade ring 20 in whose area flow disturbances occur first.

In contrast to FIG. 1, FIG. 2 shows a recirculation structure 2 integrated in a rotating hub 8. From the left to the right, a running blade ring 21, a guide blade ring 15 with radially interior, free blade ends 26 and a running blade ring 22 are visible in the main flow duct 10. Consequently, such a new arrangement of a recirculation structure should be called a “hub treatment”. The recirculation structure 2, which consists of the ring chamber 30 and the guiding elements 38 and has leading and trailing recesses 47, 48, interacts with a guide blade ring 15 which, for the most part, is situated downstream. Since the “hub treatment” rotates in this case and the guide blade ring 15 stands still, the rotational rotor speed acts completely as a differential rotational speed. In principle, the method of operation does not differ from that of a “casing treatment”. In a turbocompressor, the “casing treatment” and the “hub treatment” can also be combined and be used in several stages. Here, the radial inner contour 12 of the main flow duct corresponds to the outer contour of the hub 8.

FIG. 3 is a cross-sectional view of a detail of FIG. 1. The guiding elements 37 are sloped by an angle β with respect to the radial line such that the blade ends 25 of the running blade ring 20 deliver the recirculation flow without any major losses into the ring chamber 29, in which case the rotating direction (see arrow) should be observed. The angle of slope β may diminish from the radial interior toward the exterior to the “zero” value while the guiding elements are correspondingly curved.

A radial arrangement of the guiding elements, that is, β=0°, is possible but would probably be less advantageous for the flow.

The view according to FIG. 4 with respect to FIG. 3 shows the blade profiling of the running blade ring 20 in connection with its rotating direction (arrow) and provides a good idea of the profiling and curvature of the guiding elements 37 advantageous with respect to the flow. A person skilled in the art can see that the recirculation discharge in the area of the upstream edge 35 of the ring chamber 29 in relation to the running blade ring 20 is to take place here with a counterswirl. Reference number 36 indicates the downstream edge of the ring chamber. It is pointed out again that, in simpler constructions, the guiding elements can also consist of plane or curved “metal sheets”.

The recirculation structure 3 according to FIG. 5 is a “casing treatment” with a ring chamber 31 integrated in a casing 6. Here, the guiding elements 39 extend to the leading wall of the ring chamber 31; recesses 49 exist in the trailing area, in the direct proximity of the blade ends 27 of the running blade ring 23. The free edges 43 of the guiding elements 39 do not extend into the rotating range of the blade ends 27. Reference numbers 16 and 17 indicate the guide blade rings.

The recirculation structure 4 in FIG. 6 with the ring chamber 32 and the guiding elements 40 is also a “casing treatment” which is integrated in a casing 7 and interacts with a running blade ring 24. In contrast to FIG. 5, here the guiding elements 40 extend to the trailing wall of the ring chamber 32. Recesses 50 are provided here in the leading area. Since the free edges 44 of the guiding elements 40 extend into the rotating range of the blade ends 28, they are radially offset toward the outside in the trailing area in order to securely avoid a contact with the blades. Naturally, the edges as a whole can also be correspondingly offset.

It applies to all embodiments of the recirculation structure that the free edges 41 to 44 of the guiding elements 37 to 40 must not be radially offset toward the outside if the guiding elements are made of a soft light metal or a plastic material because a contact with the blade ends 25 to 28 can be permitted without any damage to the blades.

1. Recirculation structure for turbocompressors, having a ring chamber arranged concentrically with respect to the compressor axis in the area of the free blade ends of a blade ring, the axial center of the ring chamber being situated upstream of the axial center of the free blade ends, and the ring chamber radially adjoining the contour of the main flow duct, of the so-called annulus, and having a plurality of guiding elements which are arranged in the ring chamber, are distributed along its circumference and are arranged and shaped such that in the axially trailing area of the ring chamber, the entry of the recirculation flow takes place in an advantageous manner with respect to the flow, and in the axially leading area of the ring chamber, the exit of the recirculation flow relative to the downstream blade ring takes place in a defined direction and optionally with a defined swirl, the guiding elements having recesses for the flow passage in the circumferential direction, in the leading and/or trailing area of the ring chamber, characterized in that the side of the ring chamber (29 to 32) adjoining the contour (11, 12) of the main flow duct (9, 10) is open along its axial length, that is, from the entry to the exit of the recirculation flow, as well as along its entire circumference toward the main flow duct (9, 10), the free edges (41 to 44) of the guiding elements (37 to 40) being situated on the or close to the contour (11, 12) of the main flow duct (9, 10).

2. Recirculation structure according to claim 1, characterized in that it is arranged once or several times fixed to the casing, that is statically, in the area of one or more running blade rings (20, 23, 24) and/or once or several times fixed to the hub, that is, rotatingly, in the area of one or more guide blade rings (15).

3. Recirculation structure according to claim 1 or 2, characterized in that it is arranged in a single-stage or multistage turbocompressor in an axial, diagonal or radial construction.

4. Recirculation structure according to one of the preceding claims,
characterized in that the axially leading wall (33) and the axially trailing wall (34) of the ring chamber (29), starting from its edges (35, 36) on the contour (11) of the main flow duct (9), are sloped by the same or a different angle α upstream, that is, diagonally toward the front.

5. Recirculation structure according to claim 4, characterized in that the angle of slope a of the axially leading and the axially trailing wall of the ring chamber, starting from the radial direction, has a value in the range of from 30° to 60°.

6. Recirculation structure according to one of the preceding claims,
characterized in that the guiding elements (37 to 40) are constructed in a metal-sheet-type manner to be flat or curved, of a constant thickness, or, in a blade-type manner, to be spatially curved, of a varying thickness and with defined sections.

7. Recirculation structure according to one of the preceding claims,
characterized in that, in the axial viewing direction, the guiding elements (37 to 40) are arranged radially, sloped in the circumferential direction, or curved in the circumferential direction, in the case of a slope or a curvature, the angles β being selected such that the entry of the recirculation flow into the ring chamber (29 to 32) is fluidically facilitated, that is, takes place in a fluidically advantageous manner.

8. Recirculation structure according to one of the preceding claims,
characterized in that the ratio of the total flow volume to the total volume of the guiding elements (37 to 40) within the recirculation structure (1 to 4) is selected to be as large as possible, that is, the guiding elements (37 to 40) have a construction which is as thin-walled or thinly profiled as possible.

9. Recirculation structure according to one of the preceding claims, in which the guiding elements extend axially into the area of the free blade ends,
characterized in that the free edges (44) of the guiding elements (40), at least in the area of the free blade ends (28) are radially set back so far that, in the normal operation of the turbocompressor, no contact takes place between the blade ends (28) and the guiding elements (40).

10. Recirculation structure according to one of the preceding claims,
characterized in that the guiding elements (37 to 40) consist of metal, such as steel or of an Ni or a Co base alloy, a light metal, such as Al, or a plastic material, such as thermoplastics, duroplastics or elastomers.

11. Recirculation structure according to claim 10, characterized in that the free edges (41 to 44) of the guiding elements (37 to 40) in the case of light metal or plastic extend into the area of the free blade ends (25 to 28) and a contact is possible.

12. Aircraft engine, comprising a turbocompressor with at least one recirculation structure according to one or several of the preceding claims.

13. Industrial gas turbine, comprising a turbocompressor with at least one recirculation structure according to one or several of the preceding claims.
